(19) United States
(12) Patent Application Publication
(10) Pub. No.: US 2026/0112085 A1
(43) Pub. Date: Apr. 23, 2026

(54) DEVICES AND METHODS FOR ICON OVERLAY

(71) Applicant: Synaptics Incorporated, San Jose, CA (US)

(72) Inventors: Hikaru Shibahara, Kanagawa (JP); Ken Sato, Kanagawa (JP); Kei Miyazawa, Tokyo (JP); Nobuhiro Nagato, Kanagawa (JP); Sosuke Tsuji, Tokyo (JP); Hirobumi Furihata, Tokyo (JP); Takashi Nose, Kanagawa (JP)

(21) Appl. No.: 18/923,912

(22) Filed: Oct. 23, 2024

(51) Int. Cl. G06T 11/60

(52) U.S. Cl. CPC G06T 11/60

(57) ABSTRACT

An image processing device includes an icon overlay control circuit and an icon image overlay circuit. The icon overlay control circuit is configured to generate a first icon-overlaid frame image by blending an icon image with a first frame image using a first blending factor and determine a first icon visibility index for a first image portion of the first icon-overlaid frame image. The first image portion corresponds to the icon image. The icon overlay control circuit is further configured to determine a second blending factor based on the first icon visibility index. The icon image overlay circuit is configured to generate a second icon-overlaid frame image by blending the icon image with a second frame image using the second blending factor.

### TECHNICAL FIELD

This disclosure relates generally to display systems and more particularly to devices and methods for icon overlay in display systems.

### BACKGROUND

Display systems may be configured to display images containing one or more icons, such as tell-tale icons, to provide users with various information, such as system status information, alert information, and warning information. The icon referred to herein is a small pictogram that visually represents an object, an indication, an action, a symbol, or other concept. Such display systems may have an icon overlay function to overlay one or more icon images on a base image generated by an image source to render an icon-overlaid image. In some implementations, a display system may include an image processing device configured to implement icon overlay processing on a base image received from the image source to generate and provide an icon-overlaid image to the display device. In other implementations, one or more display drivers configured to drive a display panel may be configured as an image processing device configured to implement icon overlay processing.

### SUMMARY

This summary is provided to introduce, in a simplified form, a selection of concepts that are further described below. This summary is not necessarily intended to identify key features or essential features of the present disclosure. The present disclosure may include the following various aspects and embodiments.

In one aspect, the present disclosure provides an image processing device including an icon overlay control circuit and an icon image overlay circuit. The icon overlay control circuit is configured to generate a first icon-overlaid frame image by blending an icon image with a first frame image using a first blending factor and determine a first icon visibility index for a first image portion of the first icon-overlaid frame image. The first image portion corresponds to the icon image. The icon overlay control circuit is further configured to determine a second blending factor based on the first icon visibility index. The icon image overlay circuit is configured to generate a second icon-overlaid frame image by blending the icon image with a second frame image using the second blending factor.

In another aspect, the present disclosure provides a display device including an image processing device and a drive circuit. The image processing device is configured to generate a first icon-overlaid frame image by blending an icon image with a first frame image using a first blending factor and determine a first icon visibility index for a first image portion of the first icon-overlaid frame image. The first image portion corresponds to the icon image. The image processing device is further configured to determine a second blending factor based on the first icon visibility index and generate a second icon-overlaid frame image by blending the icon image with a second frame image using the second blending factor. The drive circuit is configured to drive a display panel based on the second icon-overlaid frame image.

In yet another aspect, the present disclosure provides a method for driving a display panel. The method includes generating a first icon-overlaid frame image by blending an icon image with a first frame image using a first blending factor and determining a first icon visibility index for a first image portion of the first icon-overlaid frame image, wherein the first image portion corresponds to the icon image. The method further includes determining a second blending factor based on the first icon visibility index and generating a second icon-overlaid frame image by blending the icon image with a second frame image using the second blending factor. The method further includes driving a display panel based on the second icon-overlaid frame image.

Other features and aspects are described in more detail below with reference to the attached drawings.

### BRIEF DESCRIPTION OF THE DRAWINGS

FIG. 1 shows an example configuration of a display system, according to one or more embodiments.

FIG. 2 shows an example configuration of icon overlay circuitry, according to one or more embodiments.

FIG. 3 shows an example icon image, according to one or more embodiments.

FIGS. 4A and 4B show an example of adjusting a blending factor (or an alpha value) for an icon image, according to one or more embodiments.

FIGS. 5A and 5B show an example process of the operation of the icon overlay control circuit shown in FIG. 2, according to one or more embodiments.

FIG. 6A shows an example of adjusting the alpha value for an icon image, according to one or more embodiments.

FIG. 6B shows an example of hunting of the alpha value for an icon image.

FIG. 7A shows an example of hysteretic adjustment of the alpha value for an icon image, according to one or more embodiments.

FIG. 7B shows an example of changes in the alpha value for an icon image in implementations in which the hysteretic adjustment is introduced, according to one or more embodiments.

FIG. 7C shows another example of hysteretic adjustment of the alpha value for an icon image, according to one or more embodiments.

FIG. 8A shows an example of “dimming” of the alpha value for an icon image, according to one or more embodiments.

FIG. 8B shows another example of “dimming” of the alpha value for an icon image, according to one or more embodiments.

FIG. 9 shows an example of adjusting the alpha value for an icon image, according to one or more embodiments.

FIG. 10 shows an example configuration of icon overlay circuitry, according to one or more embodiments.

FIG. 11 shows an example configuration of a display system, according to other embodiments.

FIG. 12 is a flowchart of an exemplary process for driving a display panel, according to one or more embodiments.

For ease of understanding, where possible, identical reference numerals have been used to designate elements that are common to the figures. It is contemplated that elements disclosed in one embodiment may be utilized in other embodiments without specific recitation. Suffixes may be appended to reference numerals to distinguish elements from one another. The drawings referenced herein are not to be construed as being drawn to scale unless specifically noted. In addition, the drawings are often simplified and details or components are omitted for clarity of presentation and explanation. The drawings and discussion serve to explain principles discussed below.

### DETAILED DESCRIPTION

The following detailed description is exemplary in nature and is not intended to limit the disclosure or the applications and uses of the disclosure. Further, there is no intention to be bound by any expressed or implied theory presented in the preceding background, summary and brief description of the drawings, or in the following detailed description.

In the following detailed description, numerous specific details are set forth in order to provide a more thorough understanding of the disclosed technology. However, it will be apparent to one of ordinary skill in the art that the disclosed technology may be practiced without these specific details. In other instances, well-known features have not been described in detail to avoid unnecessarily complicating the description.

The term “coupled” as used herein means connected directly to or connected through one or more intervening components or circuits. Further, throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Display systems may be configured to display images containing one or more icons, such as tell-tale icons, to provide users with various information, such as system status information, alert information, and warning information. Such display systems may have an icon overlay function to overlay one or more icon images on a base image generated by an image source (e.g., a processor such as an application processor, a central processing unit or other type of processor, a host computer, or an electronic control unit (ECU)) to render an icon-overlaid image. In implementations where a display system includes an image processing device (e.g., a bridge integrated circuit (IC)) configured to process image data received from an image source and provide processed image data to one or more display drivers configured to drive a display panel, the image processing device may be configured to implement the icon overlay function. In other implementations, one or more display drivers may be configured as an image processing device configured to implement the icon overlay function. The icon overlay function may be achieved using alpha blending, which is a process of combining one image with another image to create the appearance of partial or full transparency.

Since icons may be used to inform the user of important information, such as safety-related information, it may be desirable to ensure that the icons are displayed with high visibility in the icon-overlaid image. To achieve high visibility of an icon, it would be advantageous if the color of the icon is sufficiently different from the color of the image portion surrounding the icon. The present disclosure provides various techniques for improving the visibility of icons in icon-overlaid images.

In one or more embodiments, an image processing device includes an icon overlay control circuit and an icon image overlay circuit. The icon overlay control circuit is configured to generate a first icon-overlaid frame image by blending an icon image with a first frame image using a first blending factor, and to determine an icon visibility index for an image portion of the first icon-overlaid frame image, the first image portion corresponding to the icon image. The icon overlay control circuit is further configured to determine a second blending factor based on the icon visibility index. The icon image overlay circuit is configured to generate a second icon-overlaid frame image by blending the icon image with a second frame image using the second blending factor. The second blending factor may be determined by refining the first blending factor based on the icon visibility index. Determining the second blending factor based on the icon visibility index may effectively improve the visibility of the icon contained in the icon image.

In implementations where the icon image includes an icon foreground and an icon background, the icon visibility index may be determined based on respective color differences between the icon foreground and the pixels corresponding to the icon background of the image portion of the first icon-overlaid frame image. In some implementations, the blending of the icon image with the second frame image may be achieved using alpha blending, and the second blending factor is an alpha value. In such implementations, the second icon-overlaid frame image may be generated by alpha-blending the pixels of the icon background with corresponding pixels of the second frame image using the alpha value to produce corresponding pixels of the second icon-overlaid frame image, and incorporating the icon foreground as is into the second icon-overlaid frame image. The following is a detailed description of various embodiments of the present disclosure.

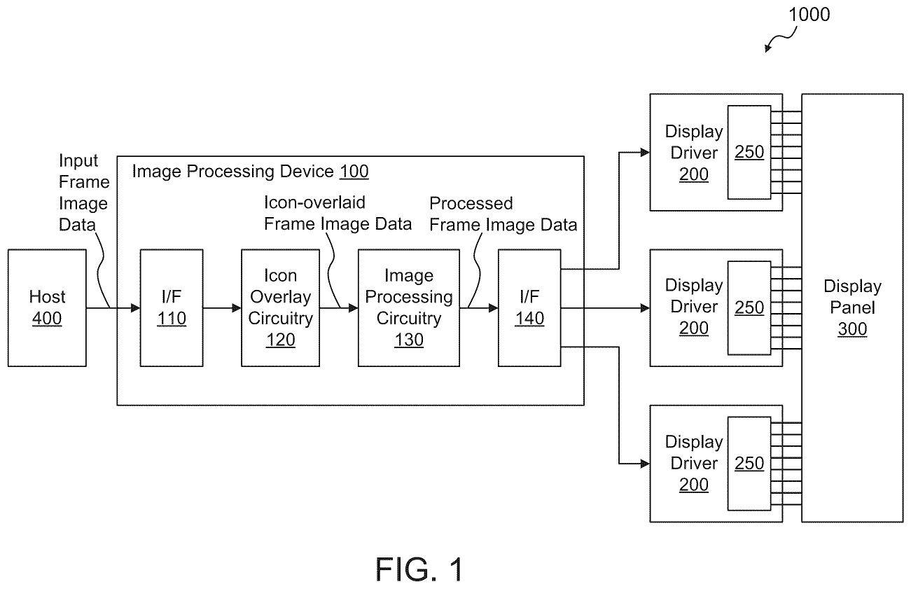

FIG. 1 shows an example configuration of a display system 1000, according to one or more embodiments. In the shown embodiment, the display system 1000 includes an image processing device 100, a plurality of display drivers 200, and a display panel 300. The image processing device 100 is configured to receive input frame image data from a host 400 and to perform image processing on the input frame image data to generate processed frame image data. In one implementation, the data communication between the image processing device 100 and the host 400 may be performed according to the embedded Display Port (eDP) protocol. The input frame image data corresponds to an input frame image and may include pixel data for respective pixels of the input frame image. The pixel data for each pixel may include a red (R) graylevel value, a green (G) graylevel value, and a blue (B) graylevel value. The host 400 may be an application processor, a central processing unit (CPU), or other processors configured to provide the input image data. Examples of the host 400 include processors such as application processors, central processing units (CPUs), and other types of processors, and controllers such as electronic control units (ECUs). In automotive applications, the image processing device 100 may be a bridge integrated circuit (IC), and the host 400 may be an ECU. As described in detail below, the image processing performed by the image processing device 100 includes icon overlay processing to overlay one or more icon images on the input frame image to generate an icon-overlaid frame image. Details of the icon overlay processing are described in detail later.

The image processing device 100 is further configured to provide the processed image data to the display drivers 200. Data communication between the image processing device 100 and the display drivers 200 may be performed according to the low voltage differential signaling (LVDS) protocol. Each display driver 200 is configured to drive a respective region of the display panel 300 based on the processed image data received by that display driver 200. The display panel 300 may be a liquid crystal display (LCD) panel, an organic light emitting diode (OLED) display panel, a micro light emitting diode (μLED) display panel, or another type of display panel of a suitable display technology. Each display driver 200 includes a drive circuit 250 configured to generate data voltages for pixels in the respective region of the display panel 300 and to drive the pixels in the respective region with the generated data voltages. While FIG. 1 shows that the display system 1000 includes three display drivers 200, fewer or more than three display drivers may be used to drive the display panel 300.

In the shown embodiment, the image processing device 100 includes an interface (I/F) 110, icon overlay circuitry 120, image processing circuitry 130, and an interface (I/F) 140. The interface 110 is configured to receive the input frame image data from the host 400, and to forward the input frame image data to the icon overlay circuitry 120. The icon overlay circuitry 120 is configured to perform icon overlay processing on the input frame image data, and thereby generating icon-overlaid frame image data. The icon-overlaid frame image data represents an icon-overlaid frame image generated by overlaying one or more icons on the input frame image. The image processing circuitry 130 is configured to perform desired image processing on the icon-overlaid frame image data to generate the processed image data to be provided to the display drivers 200. The image processing performed by the image processing device 100 may include, but is not limited to, white balance adjustment, gamma correction, contrast enhancement, color adjustment, demura correction, deburn correction, image scaling, gamma transformation, and other image processing. The interface 140 is configured to transmit the processed image data to the display drivers 200.

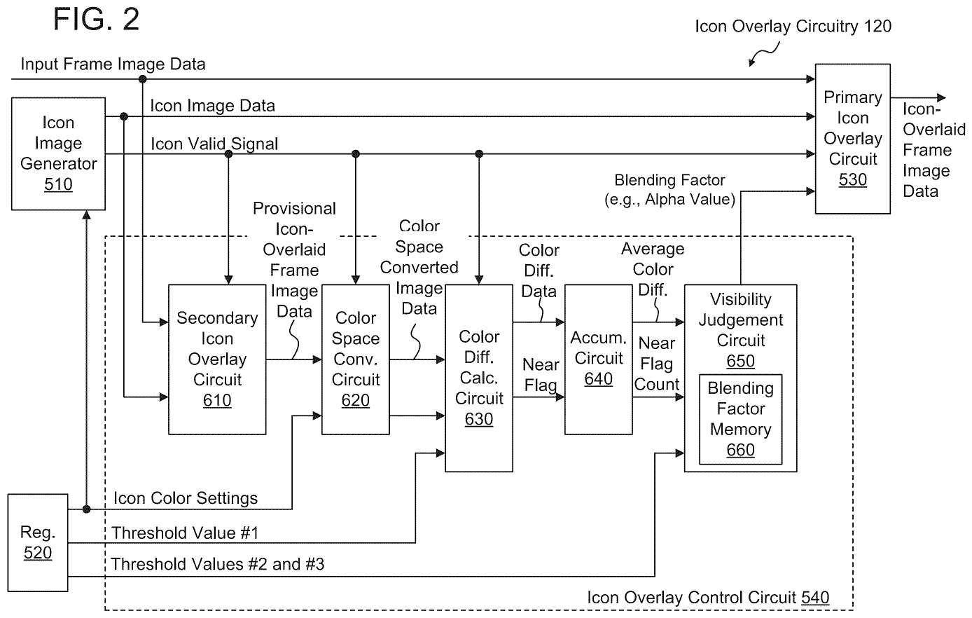

FIG. 2 shows an example configuration of the icon overlay circuitry 120, according to one or more embodiments. The icon overlay circuitry 120 includes an icon image generator 510, a register circuit 520, a primary icon overlay circuit 530, and an icon overlay control circuit 540. The icon image generator 510 is configured to generate icon image data for each icon image to be overlayed on the input frame image. The icon image data represents an icon image and includes pixel data for each pixel of the icon image. The pixel data of the icon image data for each pixel may include an R graylevel value, a G graylevel value, and a B graylevel value. The icon image data further includes a default blending factor for each pixel of the icon image. The default blending factor for each pixel may indicate the transparency of that pixel of the icon image when the icon image is overlaid on the input frame image. In embodiments where the icon overlay processing is achieved by alpha blending, the default blending factor corresponds to a default alpha value. The icon image generator 510 is further configured to generate an icon valid signal that indicates whether the pixel data of the input frame image data currently being subjected to the icon overlay processing is associated with a pixel in the portion of the input frame image on which the icon image is to be overlaid.

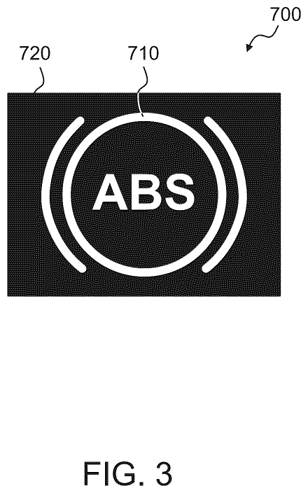

FIG. 3 shows an example icon image 700, according to one or more embodiments. The icon image 700 includes an icon foreground 710 and an icon background 720. The icon foreground 710 is the main figure that primarily represents an object, an indication, an action, a symbol, or other concept. In some implementations, such as automotive applications, the icon foreground 710 may be a single-color figure of a particular color, and the icon background 720 may be a single-color background different from the color of the icon foreground 710. While in FIG. 3 the icon foreground 710 is indicated by white and the icon background 720 is indicated by black, the icon foreground 710 and the icon background 720 may be of different colors. To ensure the visibility of the icon foreground 710, the color of the icon background 720 is determined to be sufficiently different from the color of the icon foreground 710. Since the icon foreground 710 contains information to be provided to the user, the icon foreground 710 is opaquely overlaid on the input frame image. This may be accomplished by setting the alpha values for the pixels of the icon foreground 710 to a value corresponding to opaque (e.g., zero). Meanwhile, the icon background 720 may be partially transparently overlaid on the input frame image for good appearance. This may be accomplished by setting the alpha values for the pixels of the icon foreground 710 to a value corresponding to partial transparency (e.g., a value other than zero).

Referring back to FIG. 2, the register circuit 520 is configured to store icon color settings for each icon image. The icon color settings indicate, for each icon image, the color of the icon foreground and the color of the icon background. The icon color settings may further indicate the default blending factor (e.g., the default alpha value) for the pixels of the icon background of each icon image. The icon image generator 510 may be configured to refer to the icon color settings to generate the icon image data.

The primary icon overlay circuit 530 is configured to perform icon overlay processing on the input frame image data using the icon image data, thereby generating the icon-overlaid frame image data. The icon overlay processing involves blending one or more icon images with the input frame image to generate the icon-overlaid frame image, in which the one or more icon images are overlaid on the input frame image. The icon-overlaid frame image data represents the icon-overlaid frame image so generated. In one implementation, the primary icon overlay circuit 530 may be configured to perform the icon overlay processing such that the icon foreground of each icon image is incorporated (e.g., opaquely overlaid) into the icon-overlaid frame image and the icon background of each icon image is partially transparently overlaid on the input frame image. The partially transparent overlay may be accomplished by alpha-blending the pixels of the icon background with the corresponding pixels of the input frame image to produce the corresponding pixels of the icon-overlaid frame image.

The primary icon overlay circuit 530 is configured to receive from the icon overlay control circuit 540 a blending factor for each pixel of each icon image to be overlaid on the input frame image, and to use the blending factor to generate the pixel data of the icon-overlaid frame image data for that pixel. It should be noted that the icon overlay control circuit 540 may adjust the blending factor and therefore the blending factor received from the icon overlay control circuit 540 may differ from the default blending factor provided by the icon image generator 510. In implementations where the icon overlay processing is performed using alpha blending and the blending factor for each pixel corresponds to an alpha value, the primary icon overlay circuit 530 may be configured to receive the alpha value for each pixel of each icon image from the icon overlay control circuit 540 and apply alpha blending processing to the pixel data for that pixel of the input frame image data using the pixel data for that pixel of the icon image data and the alpha value to generate the pixel data of the icon-overlaid frame image data for that pixel.

The icon overlay control circuit 540 is configured to determine and provide the blending factors (e.g., the alpha values) for the pixels of each icon image to the primary icon overlay circuit 530. The provision of the blending factors (e.g., the alpha value) is based on a provisional icon-overlaid frame image generated by blending one or more icon images with the input frame image using the default blending factors (e.g., the default alpha values) received from the icon image generator 510. It should be noted that the provisional icon-overlaid frame image is used only for evaluating the visibility of each icon image and for determining the blending factors to be provided to the primary icon overlay circuit 530. More specifically, the icon overlay control circuit 540 is configured to determine one or more icon visibility indices for the image portion of the provisional icon-overlaid frame image on which each icon image is overlaid, and to determine the blending factors to be used by the primary icon overlay circuit 530 for the pixels of each icon image based on the one or more icon visibility indices. In one or more embodiments, the one or more icon visibility indices for each icon image may be determined based on pixel data for the pixels in the image portion of the provisional icon-overlaid frame image corresponding to that icon image. More specifically, the one or more icon visibility indices for a particular icon image may be determined based on the respective color differences between the pixels of the icon foreground of that icon image and the pixels of the image portion of the provisional icon-overlaid frame image in which the icon background of that icon image is overlaid. The one or more icon visibility indices may include the number of pixels for which the color differences are less than a predetermined threshold. The one or more icon visibility indices may additionally or alternatively include the average of the color differences.

In the shown embodiment, the icon overlay control circuit 540 includes a secondary icon overlay circuit 610, a color space conversion circuit 620, a color difference calculation circuit 630, an accumulation circuit 640, and a visibility judgement circuit 650. The secondary icon overlay circuit 610 is configured to perform icon overlay processing on the input frame image data using the icon image data and the default blending factors (e.g., the default alpha values), thereby generating provisional icon-overlaid frame image data representing the provisional icon-overlaid frame image. The icon overlay processing performed by the secondary icon overlay circuit 610 is identical to the icon overlay processing performed by the primary icon overlay circuit 530 except that the icon overlay processing performed by the secondary icon overlay circuit 610 uses the default blending factors received from the icon image generator 510. In one implementation, the secondary icon overlay circuit 610 may be configured to perform the icon overlay processing such that the icon foreground of each icon image is incorporated as is (e.g., opaquely overlaid) into the provisional icon-overlaid frame image and the icon background of each icon image is partially transparently overlaid on the input frame image. The partially transparent overlay may be accomplished by alpha-blending the pixels of the icon background with the corresponding pixels of the input frame image to produce the corresponding pixels of the provisional icon-overlaid frame image.

The color space conversion circuit 620 is configured to convert the color space of the provisional icon-overlaid frame image to a target color space that facilitates color difference evaluation to generate color space converted image data. In some embodiments, the target color space may be the HSV color space or the L*a*b* color space (also referred to as the CIELAB color space) defined by the International Commission on Illumination (CIE). In other embodiments, the target color space may be a color space other than the HSV color space and the L*a*b* color space. The color space conversion circuit 620 is further configured to receive the icon color settings related to the color of the icon foreground of each icon image from the register circuit 520, and to provide a color representation of the color of the icon foreground in the target color space used to generate the color space converted image data.

The color difference calculation circuit 630 is configured to calculate the color difference between the icon foreground of each icon image and each pixel corresponding to the icon background of the provisional icon-overlaid frame image. In one implementation, the calculated color difference may be the Euclidean distance in the target color space (e.g., the HSV color space). In embodiments where the target color space is the L*a*b* color space, the calculated color difference may be the CIE76 color difference or the CIEDE2000 color difference. The color difference calculation circuit 630 is configured to provide the accumulation circuit 640 with color difference data indicative of the color difference for each pixel for which the color difference calculation is performed.

The color difference calculation circuit 630 is further configured to produce a near flag for each pixel for which the color difference calculation is performed. The near flag for a particular pixel corresponding to the icon background of a particular icon image indicates whether the color of that pixel is close to the color of the icon foreground of that icon image. In one implementation, the near flag for a particular pixel corresponding to the icon background of a particular icon image may be asserted in response to the color difference between that pixel and the icon foreground of that icon image being less than a threshold value #1. The threshold value #1 may be stored in the register circuit 520.

The accumulation circuit 640 is configured to accumulate, based on the color difference data received from the color difference calculation circuit 630, the color difference between the icon foreground and each pixel corresponding to the icon background of the provisional icon-overlaid frame image for each icon image. The accumulation circuit 640 is further configured to count the assertions of the near flag for each icon image. The count of the assertions of the near flag (which may also be referred to as the “near flag count”) for each icon image may correspond to the number of the pixels corresponding to the icon background of the provisional icon-overlaid frame image for which the color differences are less than the threshold value #1.

In the shown embodiment, the accumulation circuit 640 is configured to calculate the average of the color differences (which may simply be referred to as the average color difference) between the icon foreground and the pixels corresponding to the icon background of the provisional icon-overlaid frame image for each icon image based on the accumulation of the color differences in the accumulation circuit 640. The average color difference between the icon foreground and the pixels corresponding to the icon background of the provisional icon-overlaid frame image for each icon image is used as a first icon visibility index for that icon image, and the near flag count for each icon image is used as a second icon visibility index for that icon image. It is noted that the near flag count for a particular icon image corresponds to the number of the pixels corresponding to the icon background of that icon image of the provisional icon-overlaid frame image for which the color differences are less than threshold value #1. The average color difference and the near flag count for each icon image are provided to the visibility judgement circuit 650 as icon visibility indices.

The visibility judgement circuit 650 is configured to determine whether the visibility of each icon image in the provisional icon-overlaid frame image is sufficient based on the icon visibility indices received from the accumulation circuit 640, and to provide a blending factor (e.g., an alpha value) for each pixel of each icon image to the primary icon overlay circuit 530 based on that determination. The visibility judgement circuit 650 may be configured to, when determining that the visibility of a particular icon image in the provisional icon-overlaid frame image is sufficient, cause the primary icon overlay circuit 530 to use the default blending factors (e.g., the default alpha values) provided by the icon image generator 510. The visibility judgement circuit 650 may be further configured to, when determining that the visibility of a particular icon image in the provisional icon-overlaid frame image is insufficient, provide blending factors different from the default blending factors to ensure the sufficient visibility of that icon image. The following describes details of providing the blending factors to the primary icon overlay circuit 530, according to one or more embodiments.

The visibility judgement circuit 650 is configured to determine the blending factor (e.g., the alpha value) for the pixels of the icon background of each icon image based on the visibility of each icon image in the provisional icon-overlaid frame image. When the near flag count for that icon image is less than a threshold value #2 and the average color difference between the icon foreground and the pixels corresponding to the icon background of the provisional icon-overlaid frame image for a particular icon image is greater than a threshold value #3, the visibility judgement circuit 650 may determine that the visibility of a particular icon image in the provisional icon-overlaid frame image is sufficient. In this case, the visibility judgement circuit 650 may determine the default blending factor (e.g., the default alpha value) for the icon background of that icon image as the blending factor (e.g., the alpha value) for the icon background of that icon image to be used by the primary icon overlay circuit 530. The threshold values #2 and #3 may be stored in the register circuit 520.

If, for a particular icon image, the near flag count for that icon image is greater than the threshold value #2 or if, for a particular icon image, the average color difference between the icon foreground and the pixels corresponding to the icon background of the provisional icon-overlaid frame image is less than the threshold value #3 for a particular icon image, the visibility judgement circuit 650 may determine that the visibility of the particular icon image in the provisional icon-overlaid frame image is insufficient. In that case, the visibility judgement circuit 650 may determine the blending factor for the icon background of that icon image to be used by the primary icon overlay circuit 530 to be a value different from the default blending factor. In one implementation, the blending factor for the icon background of that icon image to be used by the primary icon overlay circuit 530 may be determined such that the icon background of that icon image is less transparent than the case when the default blending factor is used. The visibility judgement circuit 650 may be configured to store the determined blending factor for the icon background of each icon image in the blending factor memory 660.

The visibility judgement circuit 650 may be further configured to provide the blending factor for each pixel of each icon image to the primary icon overlay circuit 530 using the blending factor stored in the blending factor memory 660. More specifically, the visibility judgement circuit 650 may be configured to provide the blending factor for the pixels of the icon background of each icon image using the blending factor for that icon background stored in the blending factor memory 660. The visibility judgement circuit 650 may further be configured to provide the blending factor corresponding to opaque (e.g., the alpha value of zero) for the pixels of the icon foreground for each icon image.

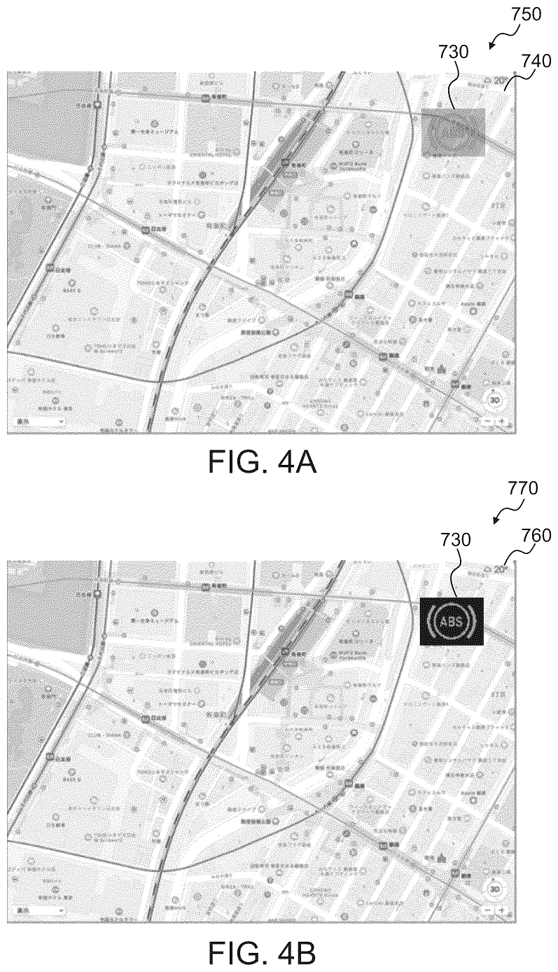

FIGS. 4A and 4B show an example of adjusting the blending factor (or the alpha value) to ensure the visibility of an icon image, according to one or more embodiments. FIG. 4A shows an example provisional icon-overlaid frame image 750 in which an icon image 730 is overlayed on an input frame image 740 using the default blending factor for the icon background. As a result of the blending (e.g., alpha blending) of the pixels of the icon background of the icon image 730 with the corresponding pixels of the input frame image 740, the image portion of the provisional icon-overlaid frame image 750 corresponding to the icon background may have a color similar to the color of the icon foreground, which may undesirably cause poor visibility of the icon image 730. Based on the image portion of the provisional icon-overlaid frame image 750 corresponding to the icon image 730, as shown in FIG. 4B, an icon-overlaid frame image 770 may be generated by overlaying the icon image 730 on an input frame image 760 of the next frame to the input frame image 740 using an adjusted blending factor. In one implementation, the adjusted blending factor may be the value corresponding to opaque (e.g., the alpha value of zero) or a value corresponding to less transparency (e.g., an alpha value less than the default alpha value). The use of the blending factor thus adjusted effectively improves the visibility of the icon image 730 because the original color of the icon background (which may be defined by the icon color settings) is defined to be sufficiently different from the icon foreground.

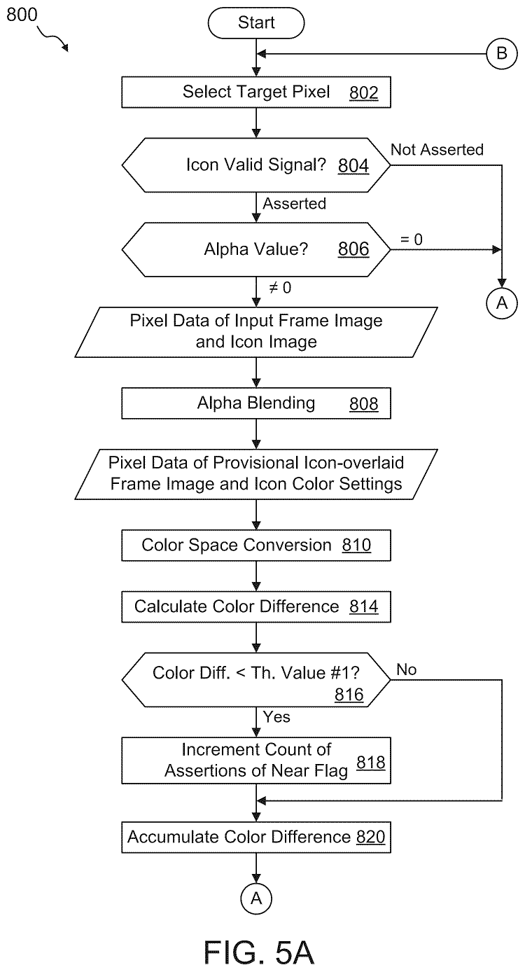

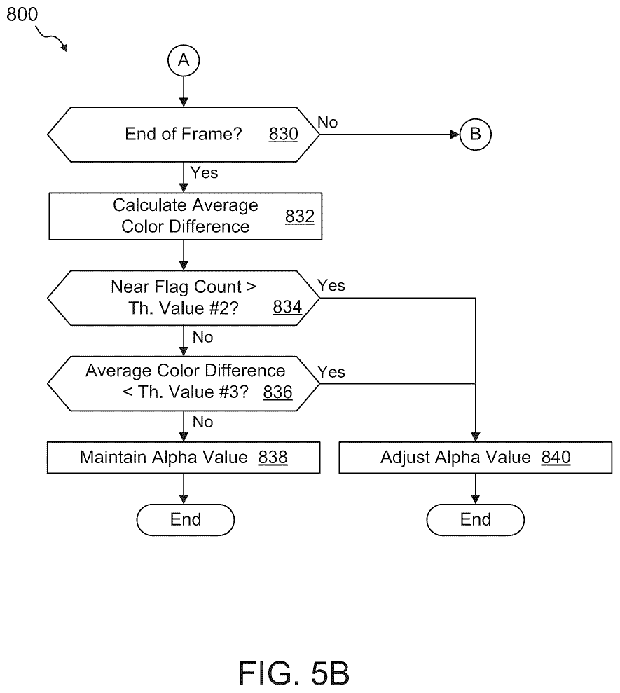

FIGS. 5A and 5B shows an example process 800 of the operation of the icon overlay control circuit 540 shown in FIG. 2, according to one or more embodiments. The shown embodiment assumes that the icon overlay process is achieved by alpha blending. It is noted that the process 800 may be implemented in a suitable environment other than the icon overlay control circuit 540.

In step 802, a target pixel is selected from the pixels of the input frame image. The selection of the target pixel may be based on a horizontal synchronization signal and a vertical synchronization signal used for horizontal and/or vertical synchronization in the display system 1000. The procedure then proceeds to step 804.

In step 804, if the icon valid signal is not asserted, the target pixel is determined to be located in the portion of the input frame image in which no icon image is overlaid, and the procedure jumps to step 830 (shown in FIG. 5B). If the icon valid signal is asserted, the target pixel is determined to be located in the portion of the input frame image in which a target icon image is to be overlaid, and pixel data of the target icon image for that target pixel, including R, G, and B graylevels and an alpha value, is provided from the icon image generator 510 to the icon overlay control circuit 540. In this case, the procedure proceeds to step 806.

In step 806, if the alpha value is zero, the target pixel is determined to correspond to the icon foreground of the target icon image, and the procedure jumps to step 830 because the icon foreground is incorporated as is into the provisional icon-overlaid frame image. Otherwise, the procedure continues to step 808, and the secondary icon overlay circuit 610 performs alpha blending on the pixel data for the target pixel of the input frame image and the pixel data for the corresponding pixel of the target icon image to generate pixel data for the target pixel of the provisional icon-overlaid frame image.

In step 810, the color space conversion circuit 620 performs a color space conversion from the RGB color space to a target color space (e.g., the HSV color space or the L*a*b* color space) for the pixel data for the target pixel of the provisional icon-overlaid frame image to generate the pixel data for the target pixel of the color space converted image. As discussed above, the target color space may be selected to facilitate color difference evaluation. In addition, the color space conversion circuit 620 generates a color representation of the color of the icon foreground of the target icon image in the target color space.

In step 814, the color difference calculation circuit 630 calculates the color difference between the icon foreground of the target icon image and the target pixel of the provisional icon-overlaid frame image. The color difference calculation is based on the color representation of the color of the icon foreground and the pixel data for the target pixel of the color space converted image generated in step 810. In one implementation, the color difference is calculated as the Euclidean distance in the target color space. In other implementations where the target color space is the L*a*b* color space, the calculated color difference may be the CIE76 color difference or the CIEDE2000 color difference. The procedure then proceeds to step 816.

In step 816, if the calculated color difference is greater than the threshold value #1, the procedure skips to step 820. If the calculated color difference is less than the threshold value #1, the color difference calculation circuit 630 asserts the near flag, and the procedure then proceeds to step 818. In step 818, the accumulation circuit 640 increments the count of the assertions of the near flag for the target icon image. It is noted that the assertions of the near flag are counted individually for each icon image. The procedure then proceeds to step 820.

In step 820, the calculated color difference is accumulated in the entry for the target icon image in the accumulation circuit 640. It is noted that the color difference is accumulated individually for each icon image. The procedure then proceeds to step 830. Reference is then made to FIG. 5B, wherein step 830 determines whether the target pixel corresponds to the end of frame of the input frame image. If not, the procedure returns to step 802. If steps 802 to 820 have been performed for all pixels of the input frame image, the procedure proceeds to step 832.

In step 832, for each icon image, the accumulation circuit 640 calculates the average color difference between the icon foreground and the pixels corresponding to the icon background of the provisional icon-overlaid frame image. The procedure then proceeds to step 834.

In step 834, the visibility judgement circuit 650 judges whether the near flag count (i.e., the count of assertions of the near flag) for each icon image exceeds the threshold value #2. It is noted that the fact that the near flag count for a particular icon image exceeds the threshold value #2 implies that the number of pixels corresponding to the icon background for which the color differences are less than the threshold value #1 exceeds the threshold value #2. If the near flag count for a particular icon image exceeds the threshold value #2, the visibility judgement circuit 650 adjusts the alpha value for the icon background of that icon image to determine an adjusted alpha value in step 840. The adjusted alpha value determined for that particular icon image is stored in the blending factor memory 660 and provided to the primary icon overlay circuit 530 as the alpha value for the pixels of the icon background of that icon image. In some implementations, the adjusted alpha value may be a fixed value, such as the value of corresponding to opaque. In implementations in which the alpha value of zero corresponds to opaque, the adjusted alpha value may be zero. In other implementations, the adjusted alpha value may be determined based on the default alpha value by modifying the default alpha value by performing arithmetic processing (e.g., subtraction, multiplication, or division) on the default alpha value.

In step 836, the visibility judgement circuit 650 judges, for each icon image, whether the average color difference between the icon foreground and the pixels corresponding to the icon background of the provisional icon-overlaid frame image is less than the threshold value #3. If the average color difference calculated for a particular icon image is less than the threshold value #3, the visibility judgement circuit 650 adjusts the alpha value for the icon background of that icon image to determine an adjusted alpha value in step 840 in a manner similar to that described above. The adjusted alpha value determined for that particular icon image is stored in the blending factor memory 660 and provided to the primary icon overlay circuit 530 as the alpha value for the pixels of the icon background of that icon image.

If the near flag count for a particular icon image is less than the threshold value #2 and the average color difference for that icon image is greater than the threshold value #3, in step 838, the default alpha value for the icon background of that icon image is stored in the blending factor memory 660, and provided to the primary icon overlay circuit 530 as the alpha value for the pixels of the icon background of that icon image.

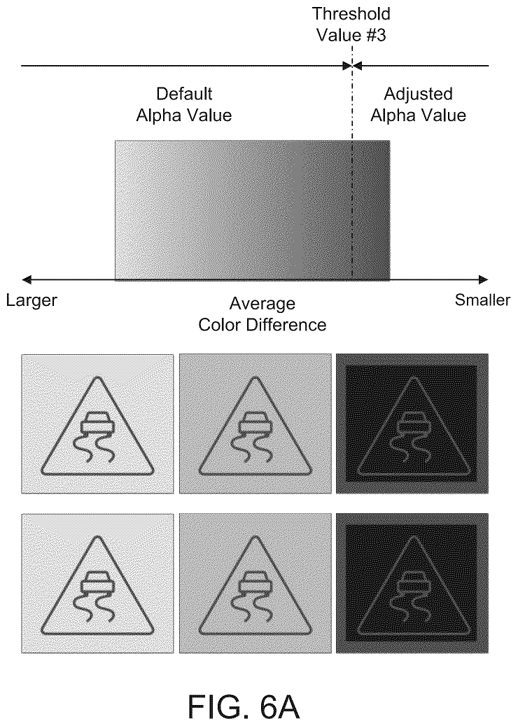

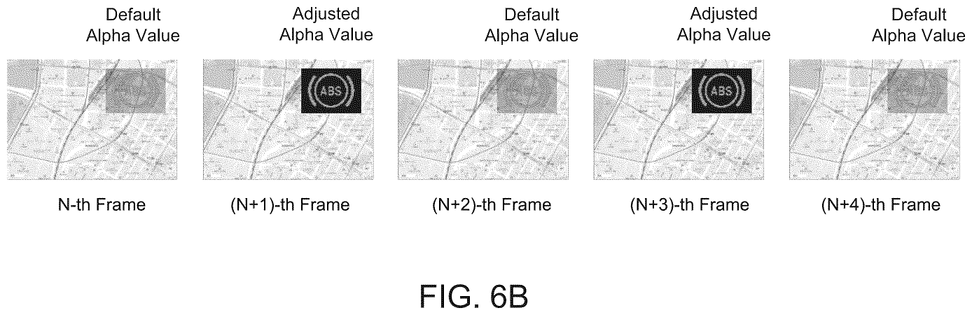

FIG. 6A shows an example of adjusting the alpha value for the icon background of a particular icon image, according to one or more embodiments. In one embodiment, if the average color difference between the icon foreground and the pixels corresponding to the icon background of an icon-overlaid frame image generated from an input frame image of a particular frame using the default alpha value for the icon background is greater than the threshold value #3, the default alpha value is used to generate the next icon-overlaid frame image generated from the input frame image of the next frame. Meanwhile, if the average color difference between the icon foreground and the pixels corresponding to the icon background of the icon-overlaid frame image is less than the threshold value #3, an adjusted alpha value is used to generate the next icon-overlaid frame image.

The adjustment of shown in FIG. 6A may however cause undesirable hunting of the alpha value when the average color difference changes in the vicinity of the threshold value #3. Hunting of the alpha value referred to herein is excessively frequent changes in the alpha value. FIG. 6B shows an example of hunting of the alpha value for a particular icon image. In the example shown, the alpha value for the icon background of the icon image used for the icon overlay processing is repeatedly changed between the default alpha value and an adjusted alpha value every frame. The hunting of the alpha value may result in a poor appearance of the icon image.

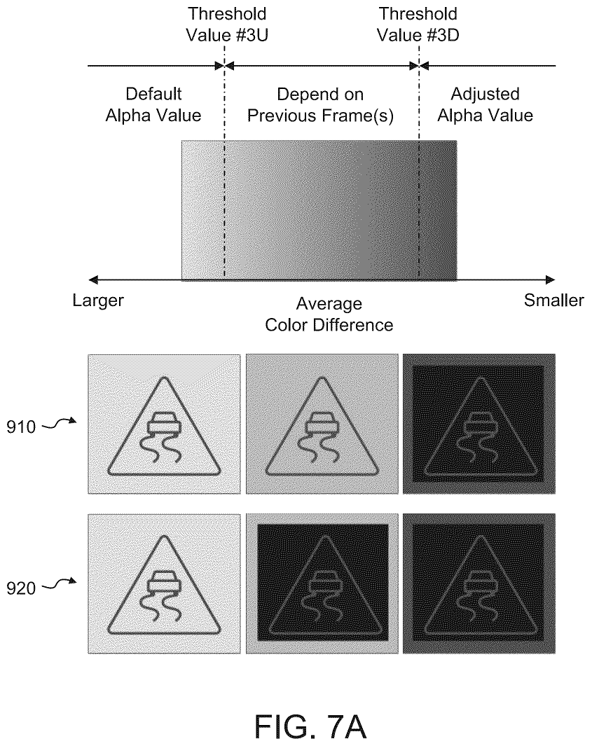

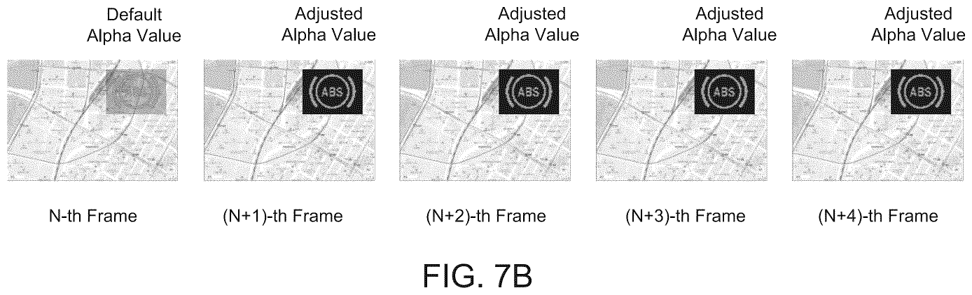

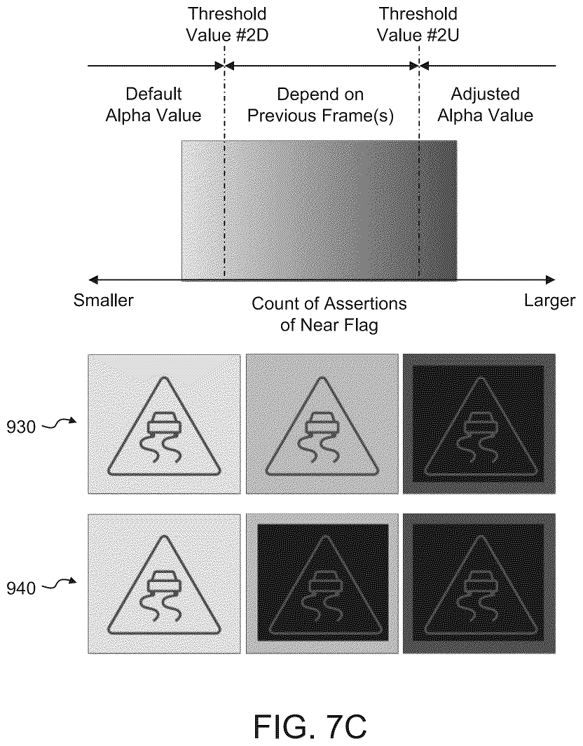

In one or more embodiments, a hysteretic adjustment of the alpha value may be introduced to avoid hunting of the alpha value. FIG. 7A shows an example of hysteretic adjustment of the alpha value for the pixels corresponding to the icon background, according to one or more embodiments. In FIG. 7A, the upper row of images 910 shows an example of a change in the alpha value as the average color difference changes from a value above a threshold value #3U to a value below a threshold value #3D that is less than the threshold value #3U, and the lower row of images 920 shows an example of a change in the alpha value as the average color difference changes from a value below the threshold value #3D to a value above the threshold value #3U. In one embodiment, the average color difference between the icon foreground and the pixels corresponding to the icon background of the provisional icon-overlaid frame image is calculated successively for each of input frame images successively provided to the icon overlay circuitry 120, and the calculated average color difference may change from the value above than the threshold value #3U to the value below the threshold value #3D. In this case, as shown in the upper row of images 910, the alpha value for the pixels corresponding to the icon background may be switched from the default alpha value and determined to the adjusted alpha value in response to the average color difference being less than the threshold value #3D. In another embodiment, the average color difference may change from the value below the threshold value #3D to the value above the threshold value #3U, as shown in the lower row of images 920. In this case, the alpha value for the pixels corresponding to the icon background may be switched from the adjusted alpha value and determined to the default alpha value in response to the average color difference being greater than the threshold value #3U. The alpha value for the case where the average color difference is in the range between the threshold values #3D and #3U may depend on input frame images of previous frames.

FIG. 7B shows an example of the changes in the alpha value in implementations in which the hysteretic adjustment is introduced, according to one or more embodiments. In the example shown, the alpha value for the icon background of the icon image used for the icon overlay processing for the input frame image of the N-th frame is the default alpha value. In response to the average color difference being less than the threshold value #3D, the alpha value for the pixels corresponding to the icon background is changed to an adjusted alpha value for the input frame image of the (N+1)-th frame. Because of the hysteretic adjustment, the alpha value used for the icon overlay processing remains the adjusted alpha value, even if the average color difference then changes in the vicinity of the threshold value #3D.

FIG. 7C shows another example of hysteretic adjustment of the alpha value based on the near flag count for an icon image, according to one or more embodiments. In FIG. 7C, the upper row of images 930 shows an example of a change in the alpha value as the near flag count changes from a value below a threshold value #2D to a value below a threshold value #2U that is greater than the threshold value #2D, and the lower row of images 940 shows an example of a change in the alpha value as the near flag count changes from a value above the threshold value #2U to a value below the threshold value 2D. In one embodiment, the near flag count is successively determined for each of input frame images successively provided to the icon overlay circuitry 120, and the near flag count may change from the value below the threshold value #2D to the value above the threshold value #2U. In this case, as shown in the upper row of images 930, the alpha value may be switched from the default alpha value and determined to the adjusted alpha value in response to the near flag count being greater than the threshold value #2U. In another embodiment, the near flag count may change from the value above the threshold value #2U to the value below the threshold value #2D, as shown in the lower row of images 940. In this case, the alpha value may be switched from the adjusted alpha value and determined to the default alpha value in response to the near flag count being less than the threshold value #2D. The alpha value for the case where the near flag count is in the range between the threshold values #2D and #2U may depend on input frame images of previous frames.

Switching the alpha value used for the icon overlay processing between the default alpha value and the adjusted alpha value may cause an abrupt change in the alpha value particularly in implementations where the adjusted alpha value differs substantially from the default alpha value. An abrupt change in the alpha value may cause an abrupt change in the appearance of the icon image, which may degrade the user experience. In one or more embodiments, to avoid abrupt changes in the appearance of the icon image, “dimming” of the alpha value may be implemented when the alpha value is to be changed between the default alpha value and the adjusted alpha value. The “dimming” of the alpha value referred to herein is to gradually change the alpha value over multiple frames.

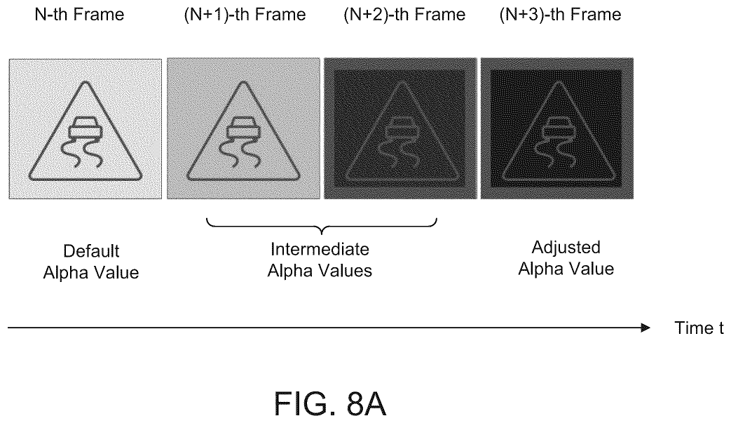

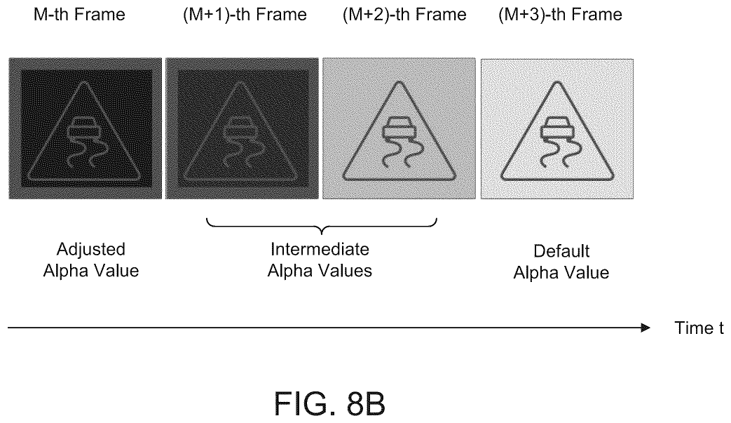

FIG. 8A shows an example of “dimming” of the alpha value for the icon background of a particular icon image, according to one or more embodiments. In the shown embodiment, in response to the average color difference being less than the threshold value #3 or #3D, the alpha value for the icon background may be gradually changed from the default alpha value to an adjusted alpha value over two or more frames. In the shown embodiment, the alpha value for the icon background is set to the default alpha value in the N-th frame, and then the alpha value is gradually changed until the alpha value reaches the adjusted alpha value in the (N+3)-th frame. The alpha value is of values between the default alpha value and the adjusted alpha value in the intermediate frames, i.e., the (N+1)-th and (N+2)-th frames.

FIG. 8B shows another example of “dimming” of the alpha value, according to one or more embodiments. In the shown embodiment, in response to the average color difference being greater than the threshold value #3 or #3U, the alpha value for the icon overlay processing may be gradually changed from the adjusted alpha value to the default alpha value over two or more frames. In the shown embodiment, the alpha value used for the icon overlay processing is set to the adjusted alpha value in the M-th frame, and then the alpha value is gradually changed until the alpha value reaches the default alpha value in the (M+3) frame. The alpha value is of values between the adjusted alpha value and the default alpha value in the intermediate frames. i.e., the (M+1)-th and (M+2)-th frames.

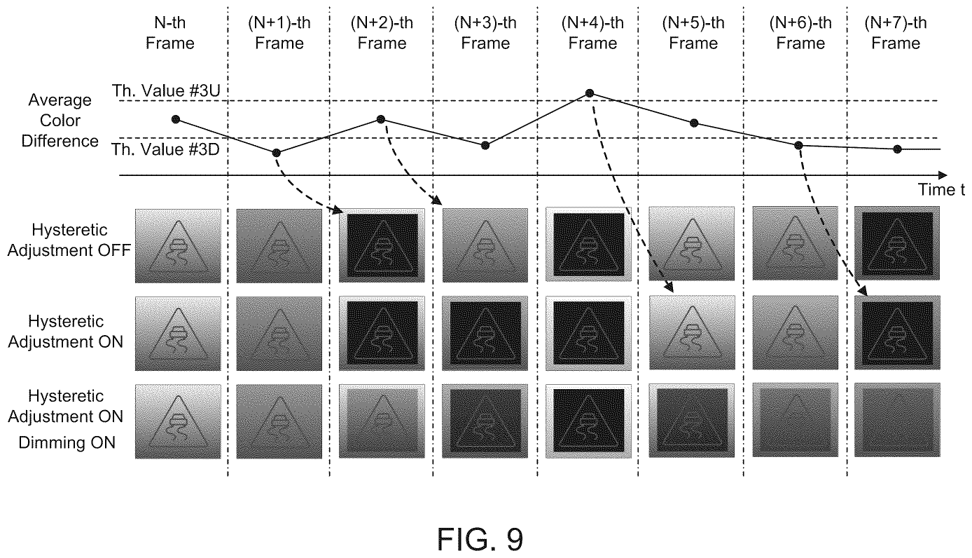

FIG. 9 shows an example of adjusting the alpha value in the case where both of the hysteretic adjustment and the dimming of the alpha value are implemented, according to one or more embodiments. When the hysteretic adjustment is disabled (indicated by “OFF” in FIG. 9), the alpha value is changed between each time the average color difference crosses the threshold value #3, resulting in hunting of the alpha value. When the hysteretic adjustment is enabled (indicated by “ON” in FIG. 9), the alpha value used for the icon overlay processing is switched from the default alpha value to the adjusted alpha value in response to the average color difference being less than the threshold value #3D, and switched from the adjusted alpha value to the default alpha value in response to the average color difference being greater than the threshold value #3U. This effectively avoids hunting of the alpha value. When the dimming function is further enabled (indicated by “ON” in FIG. 9), the alpha value is gradually changed between the default alpha value and the adjusted alpha value, which effectively prevents the appearance of the icon image from changing abruptly.

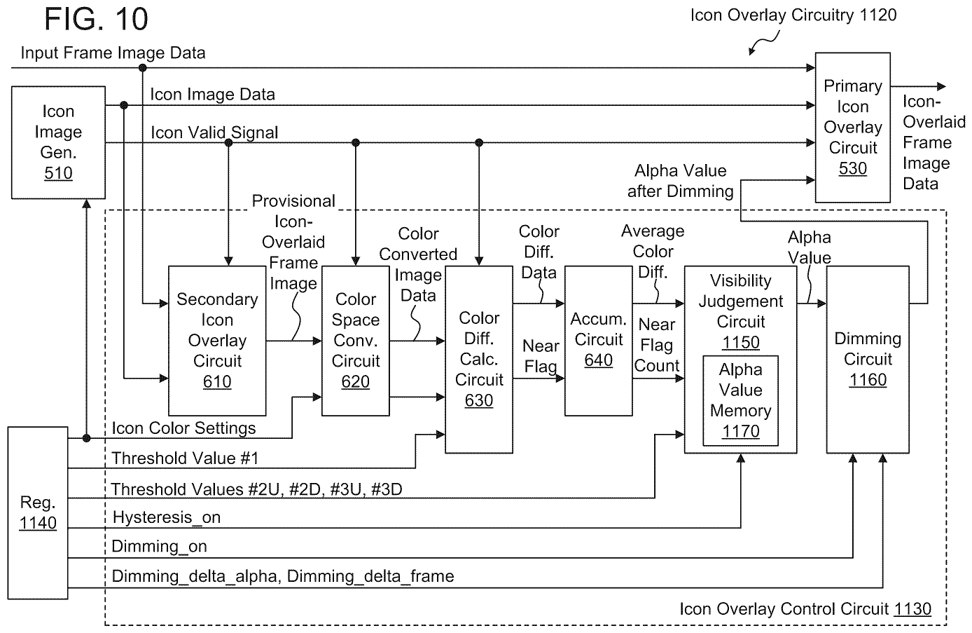

FIG. 10 shows an example configuration of icon overlay circuitry 1120 adapted for the hysteretic adjustment and the dimming of the alpha value, according to one or more embodiments. The icon overlay circuitry 1120 includes an icon overlay control circuit 1130 and a register circuit 1140. The icon overlay control circuit 1130 is configured to determine and provide the alpha value for each pixel of each icon image to the primary icon overlay circuit 530. In the shown embodiment, the icon overlay control circuit 1130 is configured similarly to the icon overlay control circuit 540 shown in FIG. 2, but includes a visibility judgement circuit 1150 and a dimming circuit 1160 instead of the visibility judgement circuit 650.

In the embodiment shown in FIG. 10, the register circuit 1140 and the visibility judgement circuit 1150 are configured to implement the above-described hysteretic adjustment of the alpha value for the icon background of each icon image. In the shown embodiment, the register circuit 1140 is configured to store the threshold values #3D and #3U used for the hysteretic adjustment shown in FIG. 7A, and the threshold values #2D and #2U used for the hysteretic adjustment shown in FIG. 7C. The visibility judgement circuit 1150 is configured to determine the alpha value for the icon background of each icon image by performing the hysteretic adjustment as shown in FIGS. 7A and 7C using the threshold values #2D, #2U, #3D, and #3U. The visibility judgement circuit 1150 may be configured to store the determined alpha value for the icon background of each icon image in the alpha value memory 1170. In one or more embodiments, the visibility judgement circuit 1150 may be responsive to a register value Hysteresis_on to select whether to enable the hysteretic adjustment. In some embodiments, the visibility judgement circuit 1150 may be configured to enable the hysteretic adjustment in response to the register value Hysteresis_on being set (e.g., to “1”), and to disable the hysteretic adjustment in response to the register value Hysteresis_on being reset (e.g., to “0”).

The dimming circuit 1160 is configured to perform the dimming of the alpha value determined for the icon background of each icon image to determine the alpha value used for the icon overlay processing for that icon background in the primary icon overlay circuit 530. In some embodiments, the step at which the alpha value is changed per frame may be indicated by a register value Dimming_delta_alpha, and the number of frames over which the alpha value is changed may be indicated by a register value Dimming_delta_frame. The register values Dimming_delta_alpha and Dimming_delta_frame may be stored in the register circuit 1140.

The dimming circuit 1160 is further configured to provide the alpha value for the pixels of the icon background of each icon image using the alpha value for that icon background determined by the dimming described in relation to FIGS. 8A and 8B, and to provide the alpha value corresponding to opaque (e.g., the alpha value of zero) for the pixels of the icon foreground for each icon image. In some embodiments, the dimming circuit 1160 may be configured to enable the dimming of the alpha value in response to the register value Dimming_on being set (e.g., to “1”), and to disable the dimming of the alpha value in response to the register value Dimming _on being reset (e.g., to “0”). In such embodiments, the dimming circuit 1160 may be configured to provide, when the dimming is disabled, the alpha value for the pixels of the icon background of each icon image using the alpha value for that icon background received from the visibility judgement circuit 1150, and to provide the alpha value corresponding to opaque (e.g., the alpha value of zero) for the pixels of the icon foreground for each icon image.

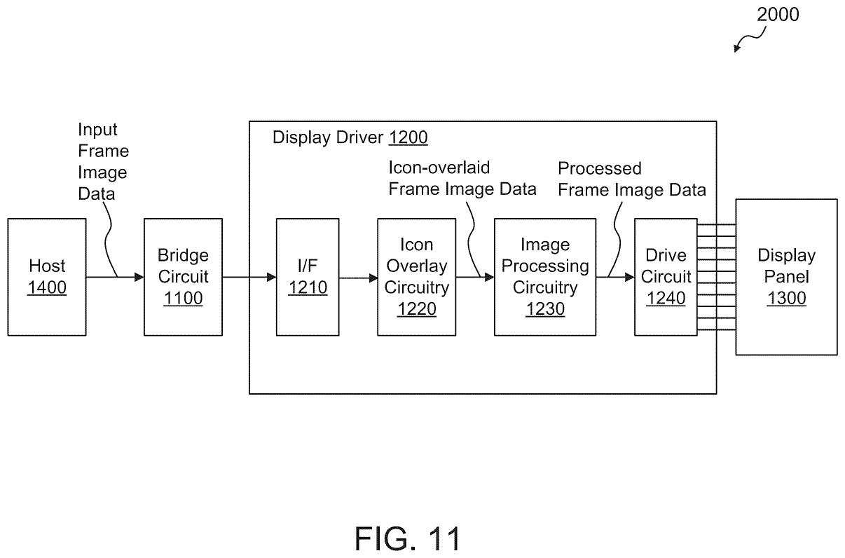

FIG. 11 shows an example configuration of a display system 2000, according to other embodiments. In the shown embodiment, the display system 2000 includes a bridge circuit (e.g., a bridge IC) 1100, a display driver 1200, and a display panel 1300, wherein the display driver 1200 is adapted for the icon overlay processing described above. More specifically, the display driver 1200 includes an interface (I/F) 1210, icon overlay circuitry 1220, image processing circuitry 1230, and a drive circuit 1240. The interface 1210 is configured to receive the input frame image data from a host 1400 via the bridge circuit 1100, and to forward the input frame image data to the icon overlay circuitry 1220. The icon overlay circuitry 1220 is configured to perform icon overlay processing on the input frame image data, and thereby generate icon-overlaid frame image data. The icon overlay processing performed by the icon overlay circuitry 1220 may be the same as the icon overlay processing performed by the icon overlay circuitry 120 shown in FIG. 2 or the icon overlay processing performed by the icon overlay circuitry 1120 shown in FIG. 10. The image processing circuitry 1230 is configured to process the icon-overlaid frame image data to generate processed frame image data. The image processing performed by the image processing circuitry 1230 may include, but is not limited to, white balance adjustment, gamma correction, contrast enhancement, color adjustment, demura correction, deburn correction, image scaling, gamma transformation, and other image processing. The drive circuit 1240 is configured to drive the display panel 1300 based on the processed image data received from the image processing circuitry 1230.

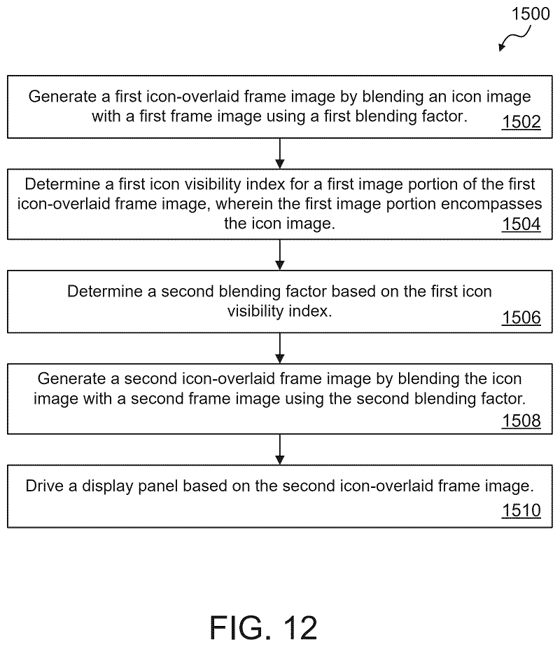

FIG. 12 is a flowchart showing an exemplary process 1500 for operating a display device, according to one or more embodiments. The process 1500 may be performed by any of the display systems 1000 and 2000 shown in FIGS. 1 and 11, particularly in the icon overlay circuitry 120 shown in FIG. 2 and the icon overlay circuitry 1120 shown in FIG. 10. However, it will be appreciated that a display device that includes additional and/or fewer components than those shown in FIGS. 1, 2, 10, and 11 may be used to perform the process 1500, that any of the following steps may be performed in any suitable order, and that the process 1500 may be performed in any suitable environment.

The process 1500 includes generating a first icon-overlaid frame image by blending (e.g., alpha blending) an icon image with a first frame image using a first blending factor (e.g., an alpha value) in step 1502. The process 1500 further includes determining a first icon visibility index for a first image portion of the first icon-overlaid frame image in step 1504. The first image portion corresponds to the icon image. In embodiments where the icon image includes an icon foreground and an icon background, the first icon visibility index may be determined based on respective color differences between first pixels of the icon foreground and second pixels of the first image portion, the second pixels corresponding to the icon background. In some implementations, the first icon visibility index may be a number of a subset of pixels from the second pixels for which the color differences are less than a predetermined threshold. In other implementations, the first icon visibility index may be an average of the color differences.

The process 1500 further includes determining a second blending factor based on the first icon visibility index in step 1506. The process 1500 further includes generating a second icon-overlaid frame image by blending the icon image with a second frame image using the second blending factor in step 1508. The process 1500 further includes driving a display panel based on the second icon-overlaid frame image in step 1510.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Exemplary embodiments are described herein. Variations of those exemplary embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. An image processing device, comprising:
an icon overlay control circuit configured to:
generate a first icon-overlaid frame image by blending an icon image with a first frame image using a first blending factor;
determine a first icon visibility index for a first image portion of the first icon-overlaid frame image, wherein the first image portion corresponds to the icon image; and
determine a second blending factor based on the first icon visibility index; and
an icon image overlay circuit configured to generate a second icon-overlaid frame image by blending the icon image with a second frame image using the second blending factor.

2. The image processing device of claim 1, wherein the icon image comprises an icon foreground and an icon background, and
wherein determining the first icon visibility index is based on respective color differences between first pixels of the icon foreground and second pixels of the first image portion, the second pixels corresponding to the icon background.

3. The image processing device of claim 2, wherein the first icon visibility index comprises a number of a subset of pixels from the second pixels for which the color differences are less than a predetermined threshold.

4. The image processing device of claim 2, wherein the first icon visibility index comprises an average of the color differences.

5. The image processing device of claim 1, wherein the second blending factor comprises an alpha value,
wherein the icon image comprises an icon foreground and an icon background,
wherein generating the second icon-overlaid frame image by blending the icon image with the second frame image comprises:
alpha blending pixels of the icon background with corresponding pixels of the second frame image using the alpha value to produce corresponding pixels of the second icon-overlaid frame image; and
incorporating the icon foreground into the second icon-overlaid frame image.

6. The image processing device of claim 1, wherein determining the second blending factor comprises adjusting the first blending factor based on the first icon visibility index.

7. The image processing device of claim 1, wherein the first blending factor has a first value,
wherein determining the second blending factor based on the first icon visibility index comprises determining the second blending factor to be a second value in response to the first icon visibility index being less than a first threshold value,
wherein the icon overlay control circuit is further configured to:
generate a third icon-overlaid frame image by blending the icon image with a third frame image using the second blending factor;
determine a second icon visibility index for a second image portion of the third icon-overlaid frame image, wherein the second image portion corresponds to the icon image; and
determine a third blending factor to be the first value in response to the second icon visibility index being greater than a second threshold value greater than the first threshold value,
wherein the icon image overlay circuit is further configured to generate a fourth icon-overlaid frame image by blending the icon image with a fourth frame image using the third blending factor.

8. The image processing device of claim 1, wherein the second frame image is provided to the image processing device after the first frame image is provided to the image processing device,
wherein the icon overlay control circuit is further configured to determine a third blending factor for a third frame image provided to the image processing device after the first frame image is provided to the image processing device and before the second frame image is provided to the image processing device, the third blending factor having a value between a first value of the first blending factor and a second value of the second blending factor, and
wherein the icon image overlay circuit is configured to generate a third icon-overlaid frame image by blending the icon image with the third frame image using the third blending factor.

9. A display device, comprising:
an image processing device configured to:
generate a first icon-overlaid frame image by blending an icon image with a first frame image using a first blending factor;
determine a first icon visibility index for a first image portion of the first icon-overlaid frame image, wherein the first image portion corresponds to the icon image;
determine a second blending factor based on the first icon visibility index; and
generate a second icon-overlaid frame image by blending the icon image with a second frame image using the second blending factor; and
a drive circuit configured to drive a display panel based on the second icon-overlaid frame image.

10. The display device of claim 9, wherein the icon image comprises an icon foreground and an icon background, and
wherein determining the first icon visibility index is based on respective color differences between first pixels of the icon foreground and second pixels of the first image portion, the second pixels corresponding to the icon background.

11. The display device of claim 10, wherein the first icon visibility index comprises a number of a subset of pixels from the second pixels for which the color differences are less than a predetermined threshold.

12. The display device of claim 10, wherein the first icon visibility index comprises an average of the color differences.

13. The display device of claim 9, wherein the second blending factor comprises an alpha value, and
wherein the icon image comprises an icon foreground and an icon background,
wherein generating the second icon-overlaid frame image by blending the icon image with the second frame image comprises:
alpha blending pixels of the icon background with corresponding pixels of the second frame image using the alpha value to produce corresponding pixels of the second icon-overlaid frame image; and
incorporating the icon foreground into the second icon-overlaid frame image.

14. The display device of claim 9, wherein the first blending factor has a first value,
wherein determining the second blending factor based on the first icon visibility index comprises determining the second blending factor to be a second value in response to the first icon visibility index being less than a first threshold value,
wherein the image processing device is further configured to:
generate a third icon-overlaid frame image by blending the icon image with a third frame image using the second blending factor;
determine a second icon visibility index for a second image portion of the third icon-overlaid frame image, wherein the second image portion corresponds to the icon image;
determine a third blending factor to be the first value in response to the second icon visibility index being greater than a second threshold value greater than the first threshold value; and
generate a fourth icon-overlaid frame image by blending the icon image with a fourth frame image using the third blending factor.

15. A method, comprising:
generating a first icon-overlaid frame image by blending an icon image with a first frame image using a first blending factor;
determining a first icon visibility index for a first image portion of the first icon-overlaid frame image, wherein the first image portion corresponds to the icon image;
determining a second blending factor based on the first icon visibility index;
generating a second icon-overlaid frame image by blending the icon image with a second frame image using the second blending factor; and
driving a display panel based on the second icon-overlaid frame image.

16. The method of claim 15, wherein the icon image comprises an icon foreground and an icon background, and
wherein determining the first icon visibility index is based on respective color differences between first pixels of the icon foreground and second pixels of the first image portion, the second pixels corresponding to the icon background.

17. The method of claim 16, wherein the first icon visibility index comprises a number of a subset of pixels from the second pixels for which the color differences are less than a predetermined threshold.

18. The method of claim 16, wherein the first icon visibility index comprises an average of the color differences.

19. The method of claim 15, wherein the second blending factor comprises an alpha value,
wherein the icon image comprises an icon foreground and an icon background,
wherein generating the second icon-overlaid frame image by blending the icon image with the second frame image comprises:
alpha blending pixels of the icon background with corresponding pixels of the second frame image using the alpha value to produce corresponding pixels of the second icon-overlaid frame image; and
incorporating the icon foreground into the second icon-overlaid frame image.

20. The method of claim 15, wherein the first blending factor has a first value,
wherein determining the second blending factor based on the first icon visibility index comprises determining the second blending factor to be a second value in response to the first icon visibility index being less than a first threshold value,
wherein the method further comprises:
generating a third icon-overlaid frame image by blending the icon image with a third frame image using the second blending factor;
determining a second icon visibility index for a second image portion of the third icon-overlaid frame image, wherein the second image portion corresponds to the icon image;
determining a third blending factor to be the first value in response to the second icon visibility index being greater than a second threshold value greater than the first threshold value; and
generating a fourth icon-overlaid frame image by blending the icon image with a fourth frame image using the third blending factor.
